(19) United States
(12) Patent Application Publication
(10) Pub. No.: US 2012/0162199 A1
(43) Pub. Date: Jun. 28, 2012

(54) APPARATUS AND METHOD FOR DISPLAYING THREE-DIMENSIONAL AUGMENTED REALITY

(75) Inventors: KEUN YOUNG LEE, Seoul (KR); KYUN YOUNG BAEK, Seoul (KR); JUNG-AH YANG, Seoul (KR); SANG-MI LEE, Seoul (KR); HYUN-SOOK LEE, Yongin-si (KR)

(73) Assignee: PANTECH CO., LTD., Seoul (KR)

(21) Appl. No.: 13/224,930

(22) Filed: Sep. 2, 2011

(30) Foreign Application Priority Data
Dec. 28, 2010 (KR) 10-2010-0136589

(51) Int. Cl. G06T 15/00

(52) U.S. Cl. 345/419

(57) ABSTRACT

In an apparatus and a method for displaying a three-dimensional augmented reality, an apparatus to display a three-dimensional augmented reality includes an object area detecting unit to detect a first object area of a left image frame of a three-dimensional image and a second object area of a right image frame of the three-dimensional image based on a selected object of the three-dimensional image; and a frame adjusting unit to adjust the left image frame and the right image frame to change a three-dimensional effect of the selected object.

### CROSS-REFERENCE TO RELATED APPLICATION

This application claims priority from and the benefit under 35 U.S.C. § 119(a) of Korean Patent Application No. 10-2010-0136589, filed on Dec. 28, 2010, which is incorporated by reference for all purposes as if fully set forth herein.

### BACKGROUND

1. Field

The following description relates to an apparatus and a method for processing augmented reality (AR) and a three-dimensional image.

2. Discussion of the Background

Augmented reality (AR) is a computer graphic scheme that deals with the combination of real world images and virtual world images, such as a virtual object and information. Augmented reality may allow a virtual objects or information to be viewed as if the virtual objects or information are components of a real world environment. Unlike conventional virtual reality, which may include only a virtual space and a virtual object, AR may further provide real world images combined with additional information that may not be obtained in the real world by overlaying a virtual object or the additional information onto the real world environment.

Meanwhile, as a mobile terminal equipped with a camera has become widely available, technologies have emerged to augment various types of information and display the augmented information on a preview image captured through the camera. For example, if a building of the surrounding real world is taken through a smart phone, a preview screen of the smart phone may display the name of the building, the stores occupying the building and the location of a restroom in the building.

In addition, as a three-dimensional image processing technique has developed, an interest to implement an augmented reality as a three-dimensional image has increased. The three-dimensional augmented reality may provide a user more realistic augmented reality experience.

However, if the augmented reality is implemented as a three-dimensional image, some of the three-dimensional augmented information may be degraded in terms of information delivery efficiency. For example, if text data included in augmented reality information is implemented as a three-dimensional image, readability of the text data may be degraded.

### SUMMARY

Exemplary embodiments of the present invention provide an apparatus and method for changing a three-dimensional effect of an object in a three-dimensional augmented reality.

Additional features of the invention will be set forth in the description which follows, and in part will be apparent from the description, or may be learned by practice of the invention.

Exemplary embodiments of the present invention provide an apparatus to display a three-dimensional augmented reality including an object area detecting unit to detect a first object area of a left image frame of a three-dimensional image and a second object area of a right image frame of the three-dimensional image based on a selected object of the three-dimensional image; and a frame adjusting unit to adjust the left image frame and the right image frame to change a three-dimensional effect of the selected object.

Exemplary embodiments of the present invention provide a method for displaying a three-dimensional augmented reality including detecting a first object area of a left image frame of a three-dimensional image and a second object area of a right image frame of the three-dimensional image; modifying the left image frame and the right image frame to change a three-dimensional effect of a selected object; and combining the left image frame and the right image frame into a modified three-dimensional image.

Exemplary embodiments of the present invention provide an apparatus to display a three-dimensional augmented reality including an object area detecting unit to detect a first object area of a left image frame of a three-dimensional image and a second object area of a right image frame of the three-dimensional image based on a selected object of the three-dimensional image; and a frame adjusting unit to modify the left image frame, the right image frame and the selected object to remove a three-dimensional effect of the selected object.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a terminal to provide three-dimensional augmented reality according to an exemplary embodiment of the present invention.

FIG. 2A is a diagram illustrating an apparatus to provide selective three-dimensional augmented reality according to an exemplary embodiment of the present invention.

FIG. 2B is a diagram illustrating an apparatus to provide selective three-dimensional augmented reality according to an exemplary embodiment of the present invention.

FIG. 3A is a diagram illustrating a three-dimensional augmented reality image according to an exemplary embodiment of the present invention.

FIG. 3B is a diagram illustrating a division of a three-dimensional augmented reality image according to an exemplary embodiment of the present invention.

FIG. 3C is a diagram illustrating movements of a left image frame and a right image frame according to an exemplary embodiment of the present invention.

FIG. 3D is a diagram illustrating rotations of a left image frame and a right image frame according to an exemplary embodiment of the present invention.

FIG. 4 is a flowchart illustrating a method for selectively removing three-dimensional effects from a three-dimensional augmented reality image according to an exemplary embodiment of the present invention.

Elements, features, and structures are denoted by the same reference numerals throughout the drawings and the detailed description, and the size and proportions of some elements may be exaggerated in the drawings for clarity and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular exemplary embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The invention is described more fully hereinafter with reference to the accompanying drawings, in which exemplary embodiments of the invention are shown.

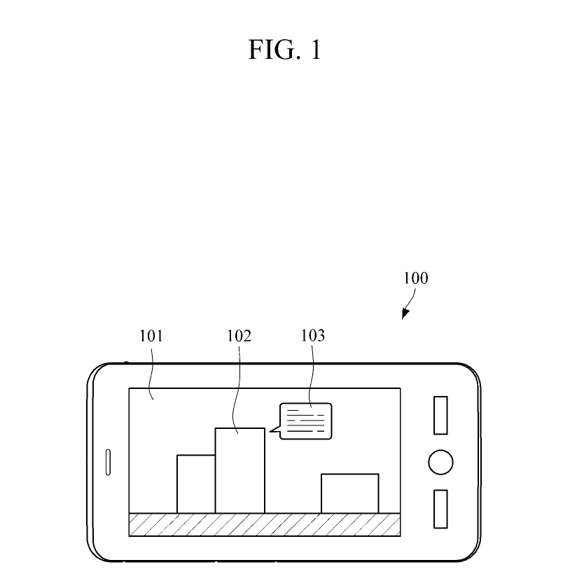

FIG. 1 is a diagram illustrating a terminal to provide three-dimensional augmented reality according to an exemplary embodiment of the present invention.

As shown in FIG. 1, a terminal 100 may display an augmented reality. The terminal 100 may include a three-dimensional (3-D) display unit 101. The 3-D display unit 101 displays an augmented reality including three-dimensional images. For example, if a user takes a picture of a region using a 3-D camera, which may be included in the terminal 100, the 3-D display unit 101 may display various types of objects 102, which are located in the region, and augmented reality information 103 related to the object 102 as a three-dimensional image.

The terminal 100 may receive the augmented reality information 103 from an augmented realty data server (not shown). For example, the terminal 100 may transmit image information, which is obtained by capturing an image of a region through the terminal 100, and position information of the terminal 100 to the augmented reality data server. The augmented reality data server may send the terminal 100 various types of information related to the region based on the received image information and the position information.

The terminal 100 may combine a left image frame and a right image frame to generate a three-dimensional augmented reality image. The left image frame represents an image obtained through a Left-camera (L-camera) corresponding to the left eye of a human, and the right image frame represents an image obtained through a Right-camera (R-camera) corresponding to the right eye of the human. The L camera and the R camera may be spaced apart from each other similar to the eyes of a human.

The augmented reality information 103 displayed on the 3-D display unit 101 may include image information and text information. The image information, such as icons, may be better displayed in a three-dimensional image. If the image information is implemented as a three-dimensional image, the image information may look more realistic. However, if the text information is implemented as a three-dimensional image, the readability of the text information may be lowered, thereby providing a user a less convenient three-dimensional augmented reality service.

The terminal 100 may display a portion of three-dimensional augmented reality information as a two dimensional image. For example, if the augmented reality information 103 about a building 102 is text information displayed as a three-dimensional image, the augmented reality information 103 may be represented as a two dimensional image. If a user selects the augmented reality information 103, a left image frame and a right image frame, which are used to generate the three-dimensional image, may be modified through image processing. Then, the modified left image frame and the modified right image frame may be recombined, so that the augmented reality information 103 does not have a three-dimensional effect. Further, a portion of the augmented reality information 103 may be selected and/or modified to be displayed in two dimensions.

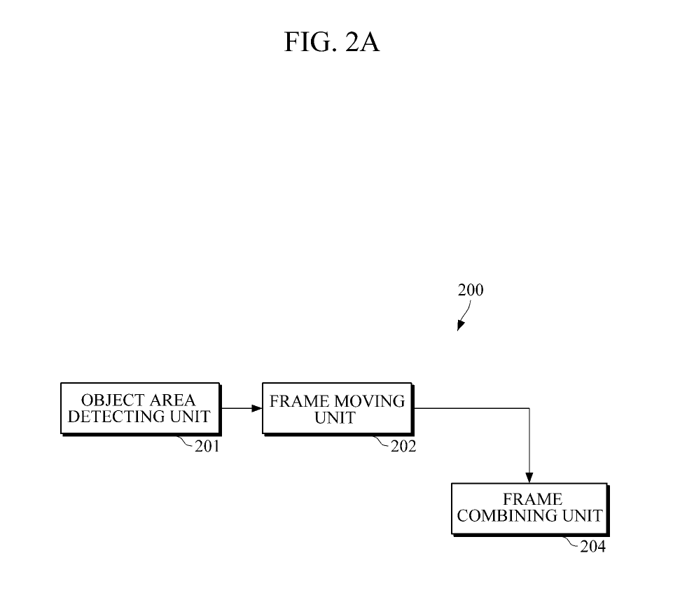

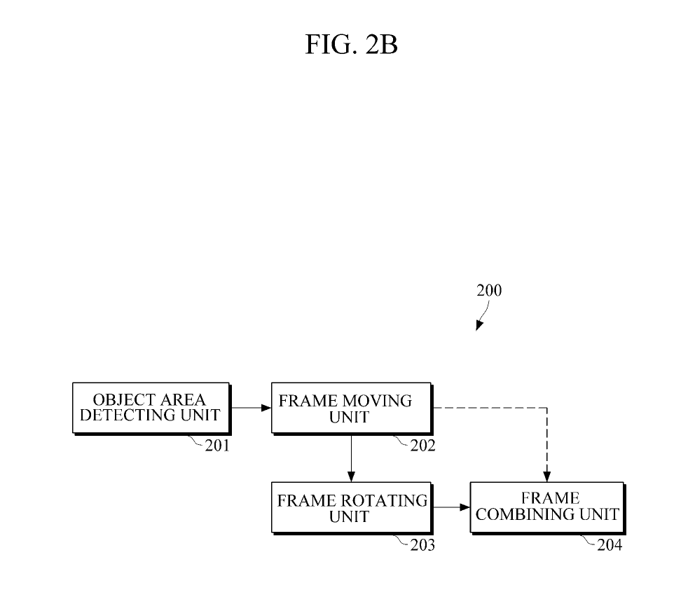

FIG. 2A is a diagram illustrating an apparatus to provide selective three-dimensional augmented reality according to an exemplary embodiment of the present invention.

Referring to FIG. 2A, an augmented reality display apparatus 200 may generate a three-dimensional image by combining a left image frame and a right image frame. In addition, the augmented reality display apparatus 200 may regenerate a three-dimensional image by recombining the left image frame and the right image frame to remove the three-dimensional effect from a portion of the three-dimensional image selectively.

The augmented reality display apparatus 200 may include an object area detecting unit 201, a frame moving unit 202 and a frame combining unit 204.

If a user selects an object in a three-dimensional image, the object area detecting unit 201 may detect each object area corresponding to the selected object from each of the left image frame and the right image frame that are used to generate the three-dimensional image. For example, if a user wants to enhance the readability of the augmented reality information 103 about the building 102, the user may select the augmented reality information 103 by selecting with a pointer or mouse icon the augmented reality information 103 or by touching the augmented reality information 103. If the augmented reality information 103 is selected by the user, the object area detecting unit 201 may divide the three-dimensional image into a left image frame and a right image frame, and detect each object area corresponding to the augmented reality information 103 from each of the left image frame and the right image frame. The object area detecting unit 201 may retrieve the left image frame and the right image frame that are used to generate the three-dimensional image from a memory unit (not shown).

The object area detecting unit 201 may detect an object area including text information even if a user does not select the object located in the object area. The object may include object information having a type of object information, such as 3-D text, 3-D icon, 2-D icon and 3-D avatar.

If each object area is detected from each of the left image frame and the right image frame, the frame moving unit 202 may reset a combining reference position of each of the left image frame and the right image frame (“two frames”). For example, before the three-dimensional image is divided, the combining reference position of the two frames may be determined as the two side edges of each of the two frames. The frame moving unit 202 may change the combining reference position of each of the two frames to correspond to each object area.

The frame moving unit 202 may adjust the combining reference position by moving the left image frame and the right image frame. For example, the frame moving unit 202 may move each of the two frames such that positions of the detected object areas of the two frames coincide with each other when the left image frame partially or wholly overlaps the right image frame. If the positions of the detected object areas of the two frames coincide with each other, new combining reference positions of the two frames may also coincide with each other because new combining reference positions are reset to each of the detected object area of the two frames.

The frame combining unit 204 may combine the left image frame and the right image frame. The left image frame and the right image frame have a coincided object area as the combining reference position, and may regenerate a modified three-dimensional image. The three-dimensional effect of an object is caused by a difference between object positions of the left image frame and the right image frame. However, the modified three-dimensional image is obtained by resetting the combining reference position of each of the two frames based on the detected object areas, and the objects of the detected object areas coincide with each other. Thus, the three-dimensional effect may be removed from the selected object. In this manner, three-dimensional effect may be selectively removed from the three-dimensional augmented reality.

FIG. 2B is a diagram illustrating an apparatus to provide selective three-dimensional augmented reality according to an exemplary embodiment of the present invention.

As shown in FIG. 2B, an augmented reality display apparatus 200 may include an object area detecting unit 201, a frame moving unit 202, a frame rotating unit 203 and a frame combining unit 204. The frame moving unit 202, the frame rotating unit 203 and the frame combining unit 204 may be included in a frame adjusting unit (not shown).

In FIG. 2B, the object area detecting unit 201 and the frame moving unit 202 may be the same as or similar to the above mentioned object area detecting unit 201 and frame moving unit 202, respectively. That is, the object area detecting unit 201 may detect an object of a three-dimensional image, and may determine each object area of the object from each of the left image frame and the right image frame of the three-dimensional image. The frame moving unit 202 may move the left image frame and the right image frame such that each combining reference position is reset to correspond to each object area.

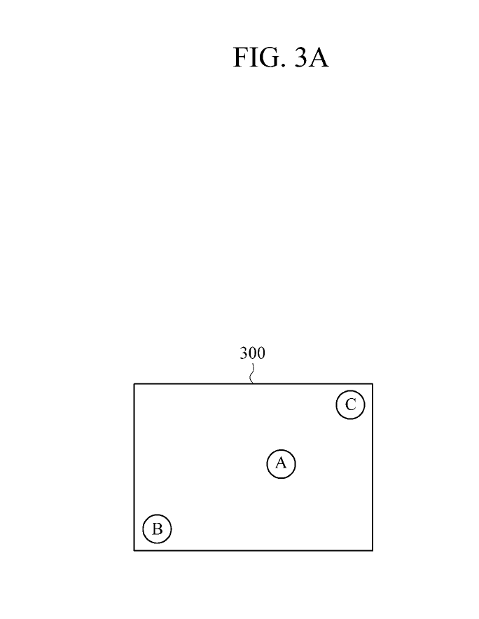

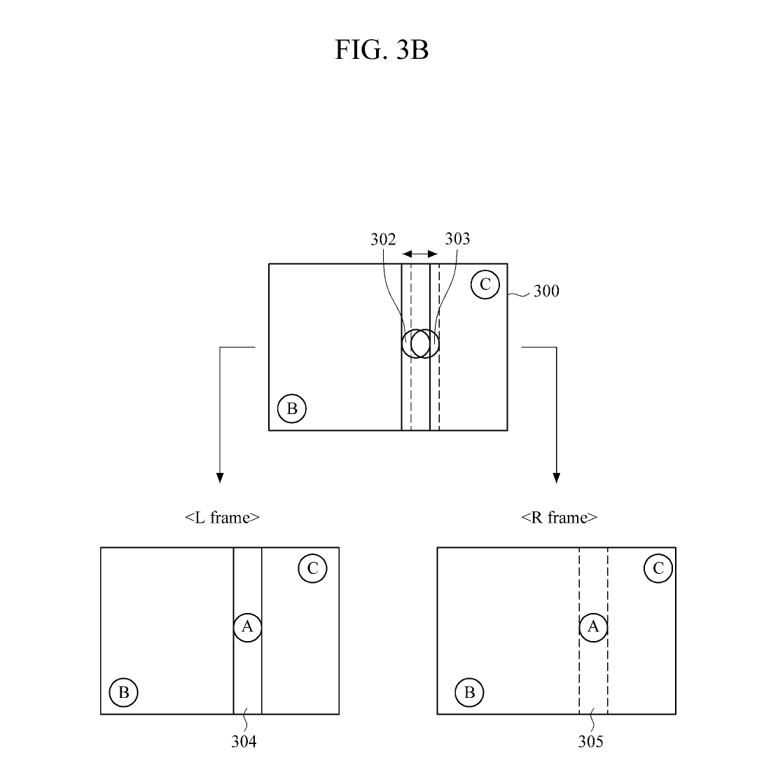

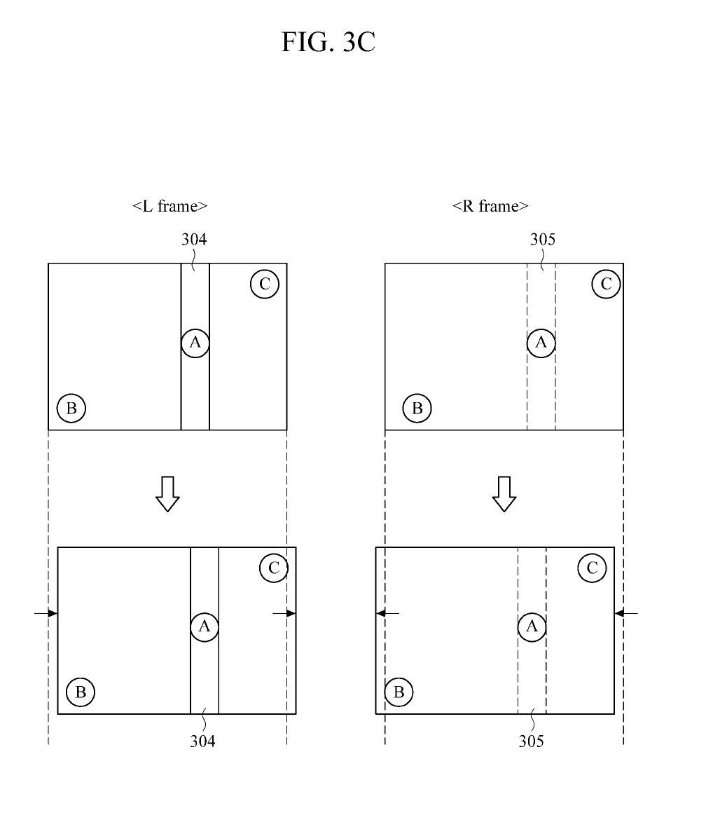

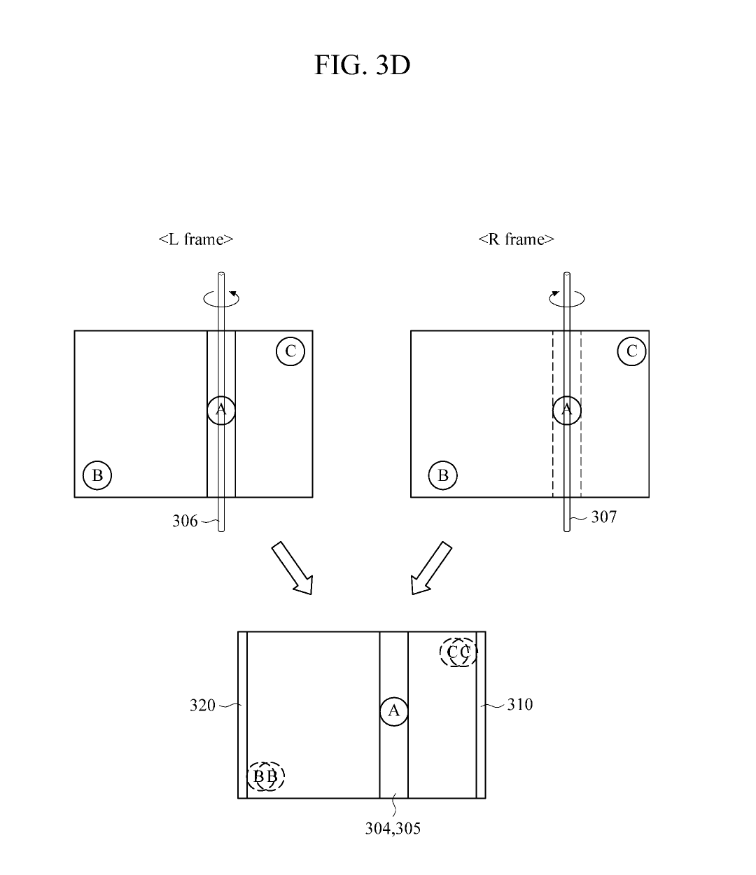

For better three-dimensional effects, the left image frame and the right image frame may be rotated based on a viewing angle and may be recombined. For example, there is a difference in a viewing angle, i.e., the angle between viewing directions from the two eyes of a viewer, when the viewer views a distant object and a close object. Here, the viewing angle is the angle between two lines of projection from an object to each of the two eyes of the viewer. That is, one of the two lines is the line of sight from the left eye of the viewer to the object, and the other of the two lines is the line of sight from the right eye of the viewer to the object. Binocular disparity resulting from the horizontal separation of the viewer's eyes may be used for better three-dimensional image processing. Thus, each of the left image frame and the right image frame may rotate around an axis based on the viewing angle or the distance of the object. The axis may be a rotation axis 306 or a rotation axis 307 that are parallel to the left image frame and the right image frame and are perpendicular to the moving direction of the left image frame and the right image frame as shown in FIG. 3D.

For rotating and combining the two frames, the frame rotating unit 203 may locate each rotation axis of the left image frame and the right image frame to each object area. For example, the frame rotating unit 203 may determine each object area of the two frames as a rotating reference position. If the frame moving unit 202 changes each combining reference position of the two frames to the position corresponding to each of the detected object areas and moves the two frames such that the detected object areas of the two frames coincide with each other, the rotating reference positions of the two frames also coincide with each other. It is because each of the rotating reference positions of the two frames is located in each of the object areas, and the object areas of the two frames coincide with each other. That is, the rotating reference position and the combining reference position may be set to the same area, the detected object area.

The frame combining unit 204 generates a modified three-dimensional image by combining the left image frame and the right image frame processed by the frame moving unit 202 and the frame rotating unit 203. As described above, the modified three-dimensional image may be generated by resetting the combining reference position and the rotating reference position of each of the two frames based on a selected object area, so that the three-dimensional effect may be selectively removed for the selected object.

FIG. 3A is a diagram illustrating a three-dimensional augmented reality image according to an exemplary embodiment of the present invention.

With reference to FIG. 2 and FIG. 3A, a three-dimensional augmented reality image 300 may include an object A, an object B and an object C. The object A may be a description about the object B and be provided in the form of a text. If the object A is implemented as a three-dimensional image, the readability of the text included in the object A may be degraded. In this regard, a user may select the object A. The object A may be selected by pointing at the object A using a mouse or a pointer or by touching the position of a display where the object A is displayed. If the user selects the object A, the object area detecting unit 201 detects each object area of the object A from each of the left image frame and the right image frame.

FIG. 3B is a diagram illustrating a division of a three-dimensional augmented reality image according to an exemplary embodiment of the present invention.

With reference to FIG. 2 and FIG. 3B, if the user selects the object A, the object area detecting unit 201 may divide the three-dimensional augmented reality image 300 into the left image frame and the right image frame. In the three-dimensional augmented reality image 300, the object A may include a left image component 302 and a right image component 303. That is, the object area detecting unit 201 may detect an area 304 corresponding to the left image component 302 of the object A from the left image frame and an area 305 corresponding to the right image component 303 of the object A from the right image frame.

FIG. 3C is a diagram illustrating movements of a left image frame and a right image frame according to an exemplary embodiment of the present invention.

With reference to FIG. 2 and FIG. 3C, if the area 304 of the object A is detected from the left image frame and the area 305 of the object A is detected from the right image frame, the frame moving unit 202 moves the left image frame and/or the right image frame such that the areas 304 and 305 of the object A coincide with each other at a target position. For example, the left image frame is moved to the right and the right image frame is moved to the left. Combining reference positions of the left image frame and the right image frame may be the area 304 and the area 305, respectively, and the frame moving unit 202 may align the left image frame and the right image frame such that the area 304 and the area 305 coincide with each other at the target position. That is, the frame moving unit 202 may align the left image frame and the right image frame in position such that the area 304 and the area 305 overlap each other that are detected from the left image frame and the right image frame, respectively. Further, the frame moving unit 202 may move or align only portions of the left image frame and the right image frame; for example, the frame moving unit 202 may move or align only the area 304 and the area 305 to align without moving the remaining portions of the left image frame and the right image frame.

FIG. 3D is a diagram illustrating rotations of a left image frame and a right image frame according to an exemplary embodiment of the present invention.

With reference to FIG. 2 and FIG. 3D, if the left image frame and the right image frame are moved and aligned based on the locations of the object areas 304 and 305, respectively, the frame rotating unit 203 may set rotation axes 306 and 307 in the left image frame and the right image frame, respectively, and rotates the two frames around the rotation axes 306 and 307, respectively. For example, the frame rotating unit 203 sets the rotation axis 306 in the object area 304 of the left image frame, and sets the rotation axis 307 in the object area 305 of the right image frame. In addition, the frame rotating unit 203 may determine a rotation angle for each of the two frames, respectively, based on the distance or the viewing angle between the user and the object A, and may rotate each of the two frames based on the rotation angle. For example, if an object is located farther from the user, the rotation angle may be determined to be smaller. If an object is located nearer to the user, the rotation angle may be determined to be greater.

If each of the two frames rotates around the rotation axis 306 and the rotation axis 307, respectively, the rotation axes located within the object areas of the object A, by a determined angle, the frame combining unit 204 may combine the rotated left image frame 310 and the rotated right image frame 320 into a modified three-dimensional augmented reality image. Since the object areas 304 and 305 of the object A coincide with each other, the object A of the left image frame 310 and the object A of the right image frame 320 are located at the same position.

The three-dimensional effect of an object is caused by a difference in position between the left image frame and the right image frame. However, the modified three-dimensional augmented reality image is obtained by realigning the combining position of the left image frame and the right image frame based on the object A. Thus, the three-dimensional effect is selectively removed for the object A.

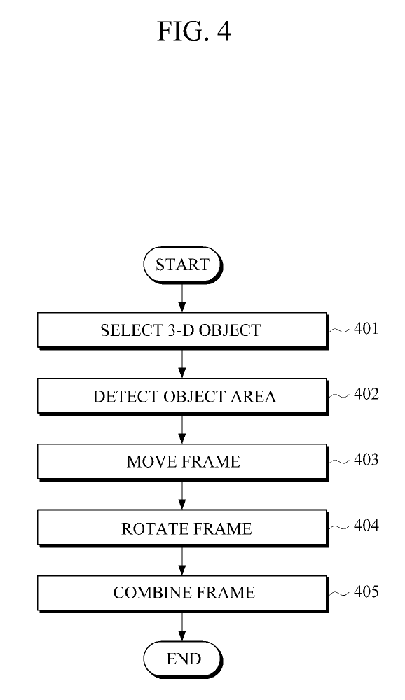

FIG. 4 is a flowchart illustrating a method for selectively removing three-dimensional effects from a three-dimensional augmented reality image according to an exemplary embodiment of the present invention.

With reference to FIG. 2 and FIG. 4, if a user selects a three-dimensional object (401), an object area of the selected object may be detected from each of a left image frame and a right image frame in operation 402. For example, if a user selects an object A as shown in FIG. 3A, which is a text object, from the three-dimensional augmented reality image 300, the three-dimensional augmented reality image 300 may be divided into the left image frame and the right image frame as shown in FIG. 3B. Then, the object area 304 and the object area 305 may be detected from the left image frame and the right image frame, respectively.

The object may be selected by a user or may be detected automatically. For example, a text object may be detected based on object information of the text object and be selected automatically.

If the object areas are detected, the left image frame and the right image frame may be moved in operation 403. For example, as shown in FIG. 3C, the left image frame and the right image frame are moved such that the combining reference positions of the left image frame and the right image frame coincide with each other at a target position.

In operation 404, a rotation axis of the left image frame and a rotation axis of the right image frame may be located at each of the object areas, and the left image frame and the right image frame may be rotated around the corresponding rotation axis. For example, as shown in FIG. 3D, the rotation reference positions of the left image frame and the right image frame are set to the object areas 304 and 305, respectively, and the two frames may rotate around the rotation axes 306 and 307, respectively.

In operation 405, a modified three-dimensional augmented reality image may be generated by combining the left image frame and the right image frame which are moved and rotated. For example, as shown in FIG. 3D, the left image frame and the right image frame are combined to generate a modified three-dimensional reality image after being rotated.

As described above, the three-dimensional effects may be selectively removed from a selected object of a three-dimensional augmented reality image. Thus, readability of a text object may be enhanced.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to display a three-dimensional augmented reality, the apparatus comprising:
an object area detecting unit to detect a first object area of a left image frame of a three-dimensional image and a second object area of a right image frame of the three-dimensional image based on a selected object of the three-dimensional image; and
a frame adjusting unit to adjust the left image frame and the right image frame to change a three-dimensional effect of the selected object.

2. The apparatus of claim 1, wherein the selected object is located within the first object area and the second object area.

3. The apparatus of claim 1, wherein the object area detecting unit detects the first object area and the second object area if the selected object includes a three-dimensional text image, or
the object area detecting unit detects the first object area and the second object area if the selected object is selected by a user.

4. The apparatus of claim 1, wherein the frame adjusting unit comprises:
a frame moving unit to move the position of the left image frame or the position of the right image frame; and
a frame combining unit to combine the left image frame and the right image frame to generate a modified three-dimensional image.

5. The apparatus of claim 4, wherein the frame moving unit moves the position of the left image frame or the position of the right image frame such that the first object area coincides with the second object area.

6. The apparatus of claim 4, wherein the frame adjusting unit further comprises:
a frame rotating unit to set a first rotation axis to the first object area and a second rotation axis to the second object area, and to rotate the left image frame around the first rotation axis and the right image frame around the second rotation axis.

7. The apparatus of claim 1, wherein the frame adjusting unit comprises:
a frame moving unit to move the position of the left image frame and the position of the right image frame; and
a frame combining unit to combine the left image frame and the right image frame to generate a modified three-dimensional image.

8. A method for displaying a three-dimensional augmented reality, the method comprising:
detecting a first object area of a left image frame of a three-dimensional image and a second object area of a right image frame of the three-dimensional image;
adjusting the left image frame and the right image frame to change a three-dimensional effect of a selected object; and
combining the left image frame and the right image frame into a modified three-dimensional image.

9. The method of claim 8, wherein the first object area and the second object area are detected if the selected object includes a three-dimensional text image, or
the first object area and the second object area are detected if the selected object is selected by a user.

10. The method of claim 8, wherein the adjusting of the left image frame and the right image frame comprises:
moving the left image frame or the right image frame such that the first object area coincide with the second object area; and
combining the left image frame and the right image frame into a modified three-dimensional image.

11. The method of claim 8, wherein the adjusting of the left image frame and the right image frame further comprises:
setting a first rotation axis of the left image frame to the first object area and a second rotation axis of the right image frame to the second object area; and
rotating the left image frame around the first rotation axis and the right image frame around the second rotation axis.

12. An apparatus to display a three-dimensional augmented reality, comprising:
an object area detecting unit to detect a first object area of a left image frame of a three-dimensional image and a second object area of a right image frame of the three-dimensional image based on a selected object of the three-dimensional image; and
a frame adjusting unit to modify the left image frame, the right image frame and the selected object to remove a three-dimensional effect of the selected object.

13. The apparatus of claim 12, wherein the selected object is located within the first object area and the second object area.

14. The apparatus of claim 12, wherein the object area detecting unit detects the first object area and the second object area if the selected object includes three-dimensional text image, or
the object area detecting unit detects the first object area and the second object area if the selected object is selected by a user.

15. The apparatus of claim 12, wherein the frame adjusting unit comprises:
a frame moving unit to move the position of the left image frame or the position of the right image frame; and
a frame combining unit to combine the left image frame and the right image frame to generate a modified three-dimensional image.

16. The apparatus of claim 15, wherein the frame moving unit moves the position of the left image frame or the position of the right image frame such that the first object area coincides with the second object area.

17. The apparatus of claim 15, wherein the frame adjusting unit further comprises:
a frame rotating unit to set a first rotation axis to the first object area and a second rotation axis to the second object area, and to rotate the left image frame around the first rotation axis and the right image frame around the second rotation axis.
